(19) United States
(12) Patent Application Publication
(10) Pub. No.: US 2023/0175729 A1
(43) Pub. Date: Jun. 8, 2023

(54) COLLECTION AND USE OF WATER FROM AN AIR CONDITIONING SYSTEM

(71) Applicant: Carrier Corporation, Palm Beach Gardens, FL (US)

(72) Inventors: Holly Dunn, Indianapolis, IN (US); Holly Rhodes, Carmel, IN (US); Francine Dash, Indianapolis, IN (US); Jeremy Riffle, Carmel, IN (US); Alissa D. Doose, Denver, CO (US); Bridget Volz, Lizton, IN (US); Michael J. Birnkrant, Manlius, NY (US); Deanne Pruitt, Irmo, SC (US); Al Blanco, Wilson, NC (US)

(21) Appl. No.: 17/992,431

(22) Filed: Nov. 22, 2022

Related U.S. Application Data
(60) Provisional application No. 63/285,813, filed on Dec. 3, 2021.

(51) Int. Cl. F24F 13/22; A01K 7/02; A01G 27/02; A01G 27/00

(52) U.S. Cl. CPC F24F 13/222; A01K 7/02; A01G 27/02; A01G 27/003; F24F 2013/227; F24F 2013/228

(57) ABSTRACT

A structure having an area to be conditioned includes an air conditioning system having a heat exchanger and a condensate drain pan positioned adjacent to the heat exchanger such that a condensate will gravitate from the heat exchanger to the condensate drain pan. A system is associated with the area to be conditioned. The system is arranged downstream from and in fluid communication with an outlet of the condensate drain pan. The condensate from the condensate drain pan is deliverable to the system automatically.

### CROSS-REFERENCE TO RELATED APPLICATIONS

This application claims the benefit of U.S. Provisional Application No. 63/285,813 filed Dec. 3, 2021, the disclosure of which is incorporated herein by reference in its entirety.

### BACKGROUND

Embodiments of the present disclosure relate to the art of air conditioning systems, and more particularly, to the repurposing of condensate collected within an air conditioning system.

A typical refrigeration cycle includes an evaporator. When the refrigeration cycle is in a cooling mode, a flow of warm air moving across the evaporator is cooled. When the air provided to the evaporator is humid, water condenses on the evaporator. This water drips from the evaporator into a condensate drain pan and may be provided to a separate water reservoir or holding tank for accumulation. In a dehumidifier, this condensate is either manually removed from the holding tank by a user, or alternatively, may be drained as waste.

### BRIEF DESCRIPTION

In an embodiment, a structure having an area to be conditioned includes an air conditioning system having a heat exchanger and a condensate drain pan positioned adjacent to the heat exchanger such that a condensate will gravitate from the heat exchanger to the condensate drain pan. A system is associated with the area to be conditioned. The system is arranged downstream from and in fluid communication with an outlet of the condensate drain pan. The condensate from the condensate drain pan is deliverable to the system automatically.

In addition to one or more of the features described above, or as an alternative to any of the foregoing embodiments comprising at least one conduit extending between the outlet of the condensate drain pan and the system.

In addition to one or more of the features described above, or as an alternative to any of the foregoing embodiments the at least one conduit extends directly between the outlet of the condensate drain pan and the system.

In addition to one or more of the features described above, or as an alternative to any of the foregoing embodiments comprising a plumbing system arranged within the structure, wherein the outlet of the condensate drain pan is arranged in fluid communication with the system via the plumbing system.

In addition to one or more of the features described above, or as an alternative to any of the foregoing embodiments the air conditioning system further comprises a reservoir configured to collect the condensate from the condensate drain pan, wherein the reservoir is arranged in fluid communication with the system.

In addition to one or more of the features described above, or as an alternative to any of the foregoing embodiments comprising at least one conduit extending between the outlet of the reservoir and the system.

In addition to one or more of the features described above, or as an alternative to any of the foregoing embodiments the at least one conduit extends directly between the outlet of the reservoir and the system.

In addition to one or more of the features described above, or as an alternative to any of the foregoing embodiments comprising a plumbing system arranged within the structure, wherein the outlet of the reservoir is arranged in fluid communication with the system via the plumbing system.

In addition to one or more of the features described above, or as an alternative to any of the foregoing embodiments the air conditioning system is a standalone unit positionable within the area to be conditioned.

In addition to one or more of the features described above, or as an alternative to any of the foregoing embodiments the air conditioning system is integrated into the structure.

In addition to one or more of the features described above, or as an alternative to any of the foregoing embodiments comprising at least one filtering device arranged along a fluid flow path extending between the outlet of the condensate drain pan and an outlet of the system.

In addition to one or more of the features described above, or as an alternative to any of the foregoing embodiments the system is a water dispenser.

In addition to one or more of the features described above, or as an alternative to any of the foregoing embodiments the system is a planter.

According to an embodiment, a method of delivering water includes collecting water with a condensate drain pan of an air conditioning system and initiating operation of a pump arranged in fluid communication with the condensate drain pan to automatically distribute water from the condensate drain pan to a system separate from the air conditioning system.

In addition to one or more of the features described above, or as an alternative to any of the foregoing embodiments initiating operation of the pump occurs at predetermined time intervals.

In addition to one or more of the features described above, or as an alternative to any of the foregoing embodiments initiating operation of the pump occurs in response to a sensor operably coupled to the pump.

In addition to one or more of the features described above, or as an alternative to any of the foregoing embodiments initiating operation of the pump further comprises monitoring a parameter of the system with the sensor and initiating operation of the pump when the parameter reaches or falls below a predetermined threshold.

In addition to one or more of the features described above, or as an alternative to any of the foregoing embodiments initiating operation of the pump further comprises controlling the pump remotely via a portable device.

In addition to one or more of the features described above, or as an alternative to any of the foregoing embodiments comprising initiating operation of the pump arranged in fluid communication with the condensate pan and distributing water from the condensate pan into a conditioned airflow output by the air conditioning system.

In addition to one or more of the features described above, or as an alternative to any of the foregoing embodiments collecting water with the condensate drain pan occurs during a first mode of operation of the air conditioning system and distributing water from the condensate pan into the conditioned airflow occurs during a second mode of operation of the air conditioning system, further comprising transforming the air conditioning system between the first mode and the second mode based on at least one of a time and a predetermined condition.

### BRIEF DESCRIPTION OF THE DRAWINGS

The following descriptions should not be considered limiting in any way. With reference to the accompanying drawings, like elements are numbered alike:

FIG. 1 is a schematic diagram of an exemplary vapor compression cycle of an air conditioning system;

FIG. 2 is a front view of an exemplary evaporator of an air conditioning system according to an embodiment;

FIG. 3 is a perspective view of an exemplary evaporator of an air conditioning system according to an embodiment;

FIG. 4A is a perspective view of an exemplary planter having a watering system according to an embodiment;

FIG. 4B is a side view of the planter of FIG. 4A according to an embodiment; and

FIG. 5 is a schematic diagram of an exemplary water dispenser according to an embodiment.

### DETAILED DESCRIPTION

A detailed description of one or more embodiments of the disclosed apparatus and method are presented herein by way of exemplification and not limitation with reference to the Figures.

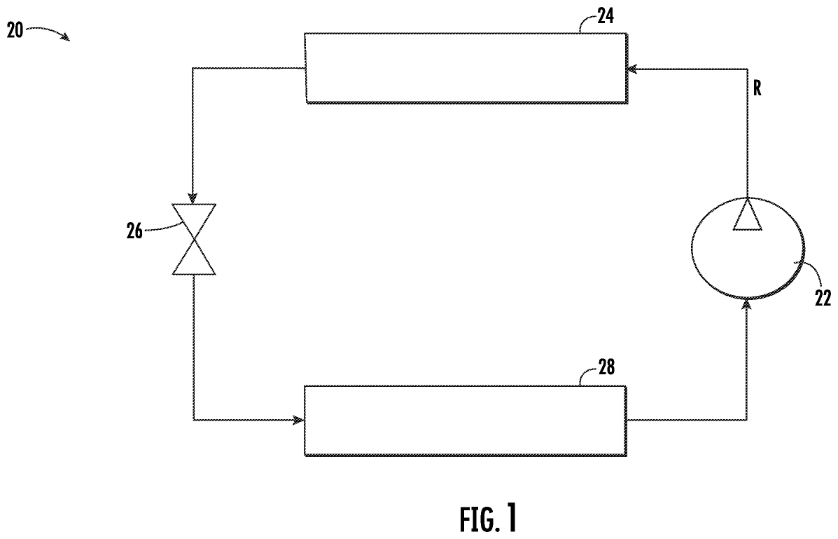

With reference now to FIG. 1, a schematic diagram of an exemplary basic vapor compression cycle of an air conditioning system 20 is illustrated. The air conditioning system 20 includes a compressor 22, a heat rejection heat exchanger (condenser) 24, an expansion device 26, and a heat absorption heat exchanger (evaporator) 28. A fluid, such as a refrigerant R for example, is configured to circulate through the vapor compression cycle, such as in a counter-clockwise direction for example.

In operation, the compressor 22 receives a refrigerant vapor R from the heat absorption heat exchanger 28 and compresses it to a high temperature and pressure. The relatively hot refrigerant vapor R is then delivered to the heat rejection heat exchanger 24 where it is cooled and condensed to a liquid state via a heat exchange relationship with a cooling medium, such as air or water. The cooled liquid refrigerant R flows from the heat rejection heat exchanger 24 to the expansion device 26, such as an expansion valve for example, in which the refrigerant R is expanded to a low temperature two phase liquid/vapor state. From the expansion device 26, the refrigerant R is provided to the heat absorption heat exchanger 28. Heat is transferred from a secondary medium, such as air for example, to the refrigerant R within the heat absorption heat exchanger 28, causing the two phase refrigerant to vaporize. From the heat absorption heat exchanger 28, the low pressure vapor refrigerant R returns to the compressor 22 so that the cycle may be repeated.

In an embodiment, the air conditioning system 20 of FIG. 1, is a ductless or standalone unit or dehumidifier that is positionable within an area to be conditioned. In other embodiments, the air conditioning system 20 is integral with and used to condition one or more areas within a residential or commercial structure. As used herein, the term “air conditioning system” is intended to include a heating, ventilation and air conditioning (HVAC) system and/or a refrigeration system including both single unit and split package systems.

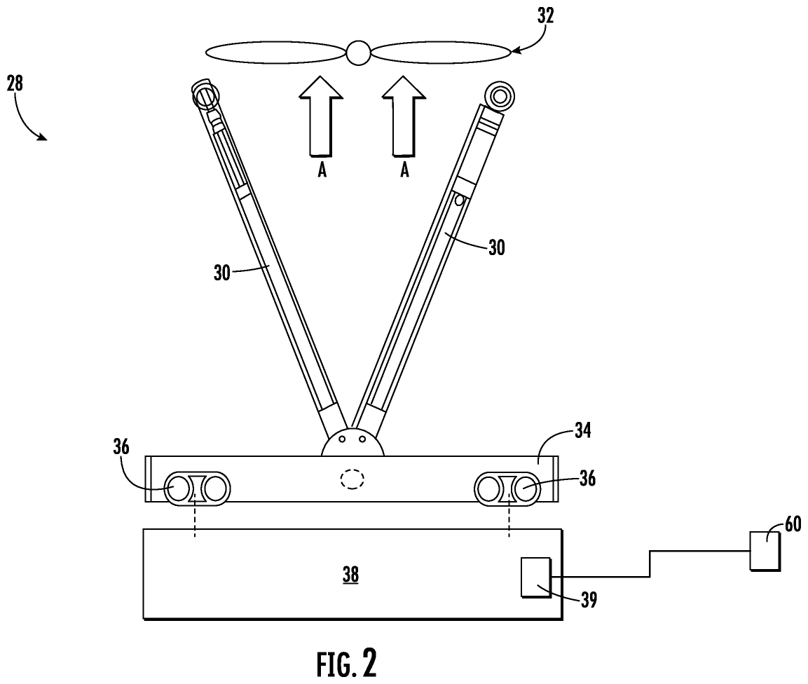

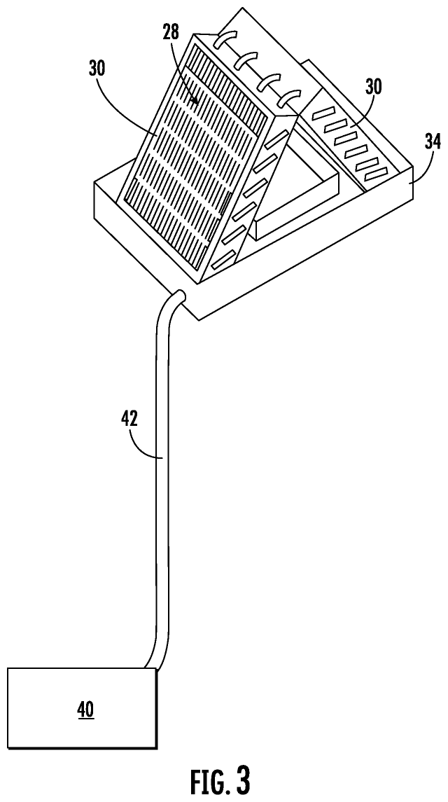

With reference to FIGS. 2 and 3, exemplary heat absorption heat exchangers or evaporators are illustrated. As shown, the heat exchanger 28 has at least one heat exchanger coil 30. In the illustrated, non-limiting embodiment, the heat exchanger 28 includes a plurality of heat exchanger coils 30 configured as a V-coil (FIG. 2) or an A-coil (FIG. 3). However, it should be understood that a heat exchanger 28 having any number of coils 30, such as a single coil, or more than two coils for example, is within the scope of the disclosure. Further, in embodiments having multiple coils 30, it should be understood that coils 30 configured in another shape, such as a W-shape or an M-shape for example, are also contemplated herein. The plurality of coils 30, may be fluidly coupled to one another, or alternatively, may be separate from one another.

The heat exchanger 28 may be any suitable type of heat exchanger configured to transfer heat between a refrigerant and air or another medium. For example, the heat exchanger 28 may include one or more coils of thermally conductive material, such as copper, aluminum, alloys thereof, or combinations thereof. In other embodiments, the heat exchanger 28 may be a shell-and tube heat exchanger, a printed circuit heat exchanger, a plate-fin heat exchanger, a microchannel heat exchanger, or any combination thereof.

A movement mechanism 32, such as a fan or blower for example, is configured to move a flow of air A having moisture entrained therein, across the one or more coils 30 of the heat exchanger 28. Although the movement mechanism 32 is illustrated as being disposed downstream from the heat exchanger 28 relative to the airflow A, and therefore in a draw-through configuration, it should be understood that embodiments where the movement mechanism 32 is positioned upstream in a blow-through configuration are also within the scope of the disclosure.

With continued reference to FIGS. 2-3, disposed vertically beneath the heat exchanger 28 is a condensate drain pan 34. The drain pan 34 is configured to capture condensation that accumulates on and/or drips from the one or more heat exchanger coils 30 of the heat exchanger 28. In existing air conditioning system or dehumidifiers, one or more conduits or channels 36 fluidly coupled to or formed in the drain pan 34 are configured to direct the condensate from the drain pan 34 to a water reservoir 38.

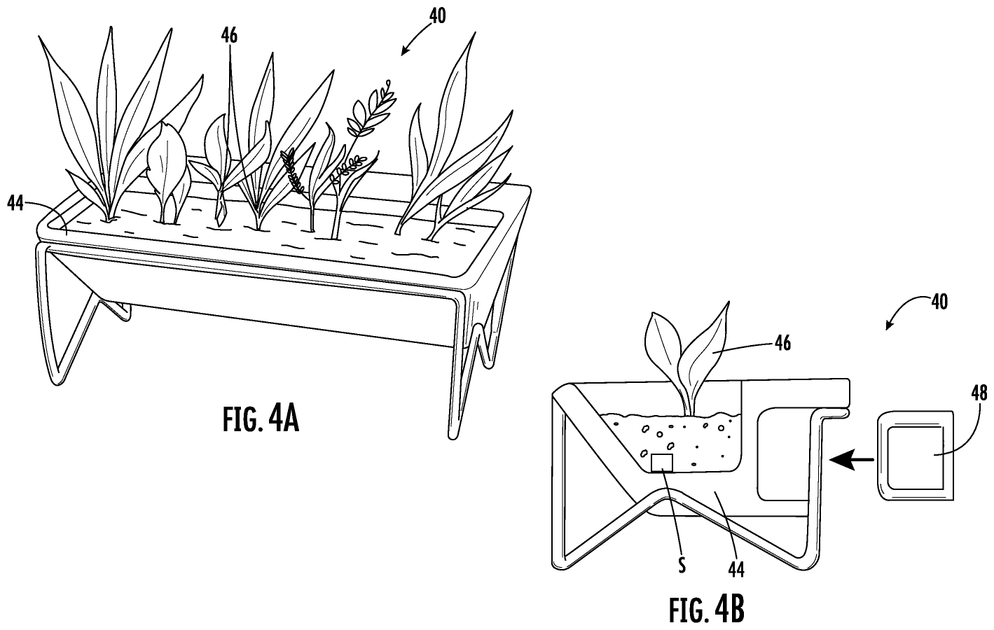

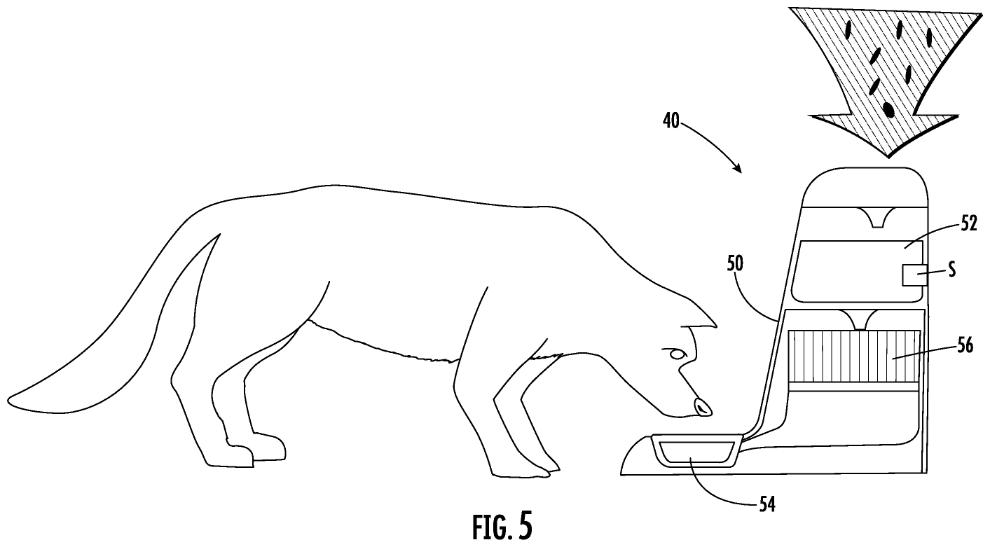

In existing air conditioning systems 20, the water that accumulates or collects within the water reservoir 38 is typically disposed of from the air conditioning system 20 as a waste by-product. With continued reference to FIGS. 2 and 3, and further reference to FIGS. 4A, 4B, and 5, in an embodiment, the water gathered within one or both of the condensate drain pan 34 and the water reservoir 38 may be automatically redirected for use by one or more other systems within or associated with the area or structure conditioned by the the air conditioning system 20. Further, the at least one system, illustrated schematically at 40, configured to receive water from the air conditioning system 20 may be a system that would typically use water provided by a user and collected from a faucet or tap.

In an embodiment, one or more of the systems 40 configured to receive water from the air conditioning system 20 is directly coupled to the drain pan 34 and/or water reservoir 38, such as by at least one conduit or pipe 42. In other embodiments, the water produced via the evaporator 28 may be delivered to the one or more systems 40 using the existing plumbing system within the residential or commercial structure. For example, water reservoir 38 may be fluidly connected to the water pipes arranged within the walls of the structure such that the water from the water reservoir 38 moves along a fluid flow path defined by the pipes and/or valves of the plumbing system. Regardless of how a system 40 is connected to the water reservoir 38 or drain pan 34, a pump 39 is operably coupled with either the water reservoir 38 or the drain pan 34, respectively, to move the water contained therein to the system(s) 40.

With continued reference to FIGS. 4A and 4B, an example of a system 40 that may be configured to use the water collected from the evaporator 28 of the air conditioning system 20 is a watering system, such as for a garden or other potted plant. In the illustrated, non-limiting embodiment, a planter 44 having one or more plants 46 contained therein has a removable water canister 48 configured to distribute water to the soil and/or plants 46 within the interior of the planter 44. Water may be automatically delivered to the water canister 48 continuously or at intervals via a connection with the air conditioning system 20 as previously described.

In another embodiment, as shown in FIG. 5, the system 40 configured to use the water collected from the evaporator 28 of the air conditioning system 20 is a potable water system, such as a water dispenser or water cooler 50. Water may be automatically delivered to the water dispenser 50, such as to an internal water reservoir 52 for example, continuously or at intervals via a connection with the air conditioning system 20 as previously described. Although the water dispenser 50 is illustrated as being in fluid communication with a dish 54 for consumption by a pet, in other embodiments, the water dispenser 50 may be suitable for use by humans. In such embodiments, the condensate output from the drain pan 34 is filtered prior to consumption.

In the illustrated, non-limiting embodiment, a filtering device 56 for removing bacteria and/or particulate matter from the water is contained within the water dispenser 50. The water dispenser 50 as shown includes a filtering device 56 disposed downstream from the water reservoir 52 relative to a fluid flow. Accordingly, the water output from the water reservoir 52 within the water dispenser 50 passes through the filtering device 56 prior to being delivered to an outlet of the water dispenser 50 arranged in fluid communication with a drinking device, such as a cup or bowl (like pet dish 54). In other embodiments, the at least one filtering device 56 may be arranged upstream from the internal water reservoir 52 such that the water is filtered as it enters the water dispenser 50 from the air conditioning system 20. Alternatively, or in addition, one or more filtering devices 56 may be external to the water dispenser 50. For example, a filtering device 56 may be arranged within the fluid flow path extending between the outlet of the drain pan 34 or water reservoir 38 and the inlet of the water dispenser 50. It should be understood that the systems 40 illustrated and described herein are intended as an example only, and that any system that uses water is within the scope of the disclosure.

To automatically distribute water from the air conditioning system 20 to the system 40, the pump 39 may be initiated in response to a timer. In another embodiment, the pump 39 is operably coupled to a component of the system 40. For example, operation of the pump 39 is initiated in response to a parameter of the system 40 measured by a sensor S, such as when the parameter reaches or falls below a predetermined threshold. In an embodiment, the planter 44 includes a soil meter, and the pump 39 is configured to deliver water to the water canister 48 when the value measured by the soil meter reaches or falls below the predetermined threshold. With respect to the water dispenser 50, a sensor S may be operable to monitor a fluid level within the water reservoir 52 and operation of the pump 39 may be initiated when the water level reaches of falls below a certain level.

In an embodiment, the pump 39 is controlled remotely, such as via a portable device, illustrated schematically at 60. Examples of a portable device 60 include, but are not limited to, a computer, a tablet, a personal digital assistant (PDA), a smartphone, a cellular device with SMS capabilities, or any other device configured to generate a signal. The portable device 60 may communicate with the pump 39 via any suitable type of communication including, but not limited to, Bluetooth, a local or public data network, radio frequency, a cellular network, near field communication, or any other wireless or wired network. In an embodiment, an application or “app” associated with the portable device 60 is used to establish communication with the pump 39, such as to initiate operation thereof, or to set a schedule for intervals of operation for example.

Further, in an embodiment, the air conditioning system 20 may be operated as a humidifier. For example, the pump 39 may be operable to deliver water from the water reservoir 38 to the air being exhausted from the air conditioning system 20, thereby increasing the humidity of the air. In such embodiments, the air conditioning system 20 is operable in a first mode as a dehumidifier and is operable in a second mode as a humidifier. In such embodiments, the air conditioning system 20, and in some embodiments the pump 39, is controlled to operate in a first mode at a certain time or in response to a first condition and to operate in the second mode at a certain time or in response to a second condition. In an embodiment, the air conditioning system is operable in the first mode as a dehumidifier generally during the day, and is configured to transform and operate in the second mode as a humidifier generally at night.

An air conditioning system 20 as described herein repurposes the collected water or condensate from an air conditioning system for another use within the structure containing the area being conditioned. reduces the water usage of one or more systems associated with the structure, other than the air conditioning system.

The term “about” is intended to include the degree of error associated with measurement of the particular quantity based upon the equipment available at the time of filing the application.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

While the present disclosure has been described with reference to an exemplary embodiment or embodiments, it will be understood by those skilled in the art that various changes may be made and equivalents may be substituted for elements thereof without departing from the scope of the present disclosure. In addition, many modifications may be made to adapt a particular situation or material to the teachings of the present disclosure without departing from the essential scope thereof. Therefore, it is intended that the present disclosure not be limited to the particular embodiment disclosed as the best mode contemplated for carrying out this present disclosure, but that the present disclosure will include all embodiments falling within the scope of the claims.

What is claimed is:

1. A structure having an area to be conditioned, the structure comprising:
an air conditioning system including a heat exchanger and a condensate drain pan positioned adjacent to the heat exchanger such that a condensate will gravitate from the heat exchanger to the condensate drain pan;
a system associated with the area to be conditioned, the system being arranged downstream from and in fluid communication with an outlet of the condensate drain pan, wherein the condensate from the condensate drain pan is deliverable to the system automatically.

2. The structure of claim 1, further comprising at least one conduit extending between the outlet of the condensate drain pan and the system.

3. The structure of claim 2, wherein the at least one conduit extends directly between the outlet of the condensate drain pan and the system.

4. The structure of claim 1, further comprising a plumbing system arranged within the structure, wherein the outlet of the condensate drain pan is arranged in fluid communication with the system via the plumbing system.

5. The structure of claim 1, wherein the air conditioning system further comprises a reservoir configured to collect the condensate from the condensate drain pan, wherein the reservoir is arranged in fluid communication with the system.

6. The structure of claim 5, further comprising at least one conduit extending between the outlet of the reservoir and the system.

7. The structure of claim 6, wherein the at least one conduit extends directly between the outlet of the reservoir and the system.

8. The structure of claim 5, further comprising a plumbing system arranged within the structure, wherein the outlet of the reservoir is arranged in fluid communication with the system via the plumbing system.

9. The structure of claim 1, wherein the air conditioning system is a standalone unit positionable within the area to be conditioned.

10. The structure of claim 1, wherein the air conditioning system is integrated into the structure.

11. The structure of claim 1, further comprising at least one filtering device arranged along a fluid flow path extending between the outlet of the condensate drain pan and an outlet of the system.

12. The structure of claim 11, wherein the system is a water dispenser.

13. The structure of claim 1, wherein the system is a planter.

14. A method of delivering water comprising:
collecting water with a condensate drain pan of an air conditioning system; and
initiating operation of a pump arranged in fluid communication with the condensate drain pan to automatically distribute water from the condensate drain pan to a system separate from the air conditioning system.

15. The method of claim 14, wherein initiating operation of the pump occurs at predetermined time intervals.

16. The method of claim 14, wherein initiating operation of the pump occurs in response to a sensor operably coupled to the pump.

17. The method of claim 16, wherein initiating operation of the pump further comprises:
monitoring a parameter of the system with the sensor; and
initiating operation of the pump when the parameter reaches or falls below a predetermined threshold.

18. The method of claim 14, wherein initiating operation of the pump further comprises controlling the pump remotely via a portable device.

19. The method of claim 14, further comprising:
initiating operation of the pump arranged in fluid communication with the condensate pan; and
distributing water from the condensate pan into a conditioned airflow output by the air conditioning system.

20. The method of claim 19, wherein collecting water with the condensate drain pan occurs during a first mode of operation of the air conditioning system and distributing water from the condensate pan into the conditioned airflow occurs during a second mode of operation of the air conditioning system, further comprising transforming the air conditioning system between the first mode and the second mode based on at least one of a time and a predetermined condition.
